(19) United States
(12) Patent Application Publication
(10) Pub. No.: US 2015/0093500 A1
(43) Pub. Date: Apr. 2, 2015

(54) Corrosion-Resistant Silver Coatings with Improved Adhesion to III-V Materials

(71) Applicant: Intermolecular, Inc., San Jose, CA (US)

(72) Inventors: Teresa B. Sapirman, Mountain View, CA (US); Jianhua Hu, Palo Alto, CA (US); Minh Huu Le, San Jose, CA (US)

(73) Assignee: Intermolecular, Inc., San Jose, CA (US)

(21) Appl. No.: 14/136,125

(22) Filed: Dec. 20, 2013

Related U.S. Application Data
(60) Provisional application No. 61/884,265, filed on Sep. 30, 2013.

(51) Int. Cl. H01B 13/00

(52) U.S. Cl. CPC H01B 13/0026
USPC 427/124; 427/125

(57) ABSTRACT

The electrical and optical performance of silver LED reflective contacts in III-V devices such as GaN LEDs is limited by silver's tendency to agglomerate during annealing processes and to corrode on contact with silver-reactive materials elsewhere in the device (for example, gallium or aluminum). Agglomeration and reaction are prevented, and crystalline morphology of the silver layer may be optimized, by forming a diffusion-resistant transparent conductive layer between the silver and the source of silver-reacting metal, (2) doping the silver or the diffusion-resistant transparent conductive layer for improved adhesion to adjacent layers, or (3) doping the silver with titanium, which in some embodiments prevents agglomeration and promotes crystallization of the silver in the preferred <111> orientation.

### BACKGROUND

Related fields include light-emitting diodes (LEDs), laser diodes, and other optical, electronic, and optoelectronic devices based on III-V semiconductor materials (e.g., gallium nitride (GaN), aluminum nitride (AlN), indium nitride (InN), and ternary or quarternary nitrides and phosphides such as AlGaN, InGaN, GaInAsN, and GaInPN).

A typical LED stack includes an active semiconductor layer sandwiched between p-type and n-type semiconductor layers. Electroluminescence results when electrons from the n-type layer and “holes” from the p-type layer meet and combine in the active photoemissive layer. Substrates made of III-V materials have historically been very expensive. GaN and AlN substrates are becoming increasingly available, but are still prone to problems related to stability and defects. A common alternative approach has been to grow the III-V layers by epitaxy on some other material such as sapphire (Al₂O₃), silicon (Si), silicon carbide (SiC), germanium (Ge), zinc oxide (ZnO), and glass.

A “junction-up” LED emits light from the side opposite the substrate, through a semi-transparent contact. Some junction-up LEDs have one contact on the “top” (the side of the film stack farthest from the substrate) and one on the “bottom” (the side of the film stack nearest the substrate). An inverted LED is fabricated to emit light toward the substrate. Depending on the design, the substrate may be removed before packaging, or may remain in place and become a transparent “superstrate.” A common challenge in designing electrical contacts for LEDs is that their optical properties are constrained along with their electrical properties. Current must enter the light-emitting stack, but light must also be able to exit.

Efficient light output in an LED can depend partially on the reflectivity of an internal reflector. Light radiating in some directions would ordinarily be absorbed by components behind or beside the light-emitting element, where it would be converted to waste heat and never reach the intended field of illumination. A reflector may be positioned inside the device to capture this light and redirect it toward the intended field of illumination. Some LED reflectors are made of conductive materials and also serve as electrodes or other electrical contacts. These dual-purpose components are referred to as “reflective contacts.”

Silver (Ag) is highly electrically conductive and also highly reflective over a broad range of optical wavelengths. It reflects visible wavelengths (˜400-650 nm) more efficiently than other readily available conductive metals such as aluminum, copper, and gold. However, several obstacles have hindered the cost-effective mass production of LEDs with internal silver reflectors.

Corrosion can adversely affect both conductivity and reflectivity. Thin silver films are subject to corrosion when they chemically react with other metals used in LED manufacture, such as gallium (Ga) and aluminum (Al) (collectively, “silver-reactive materials”). The metallic components of a number of III-V materials have been observed to corrode silver by wicking and penetrating into grain boundaries in the silver crystalline structure. Surface roughness can also detract from reflectivity. Silver has a high surface energy, which can cause a thin film to agglomerate into islands when exposed to high temperatures. The islands form a rougher surface than the smooth contiguous film as originally deposited. When silver crystallizes, some crystalline orientations are better reflectors than others, but the crystalline orientation can be difficult to control. Finally, adhesion to the underlying layer is an important factor in both reflectivity and conductivity. The tendency to agglomerate also compromises adhesion.

Therefore, a need exists for an effective, manufacturable way to prevent corrosion and agglomeration, promote adhesion, and control crystalline orientation of silver films in LEDs, laser diodes, and other III-V devices.

### SUMMARY

The following summary presents some concepts in a simplified form as an introduction to the detailed description that follows. It does not necessarily identify key or critical elements and is not intended to reflect a scope of invention.

Reflectivity and conductivity are improved in silver reflective contacts for III-V devices by preventing reaction with nearby silver-reactive materials and by preventing agglomeration of the silver layer. Reactions are prevented by interposing a barrier layer between the silver and a silver-reactive material. In some embodiments, the silver may be doped to render it less reactive with the silver-reactive material, more adhesive to the barrier layer, or more likely to form crystals in a desired orientation. In some embodiments, agglomeration is prevented by depositing the silver on a barrier layer rather than directly on the III-V material, or by doping the silver to reduce its tendency to agglomerate.

A barrier layer of diffusion-resistant transparent conductive material may be formed between the silver layer and any silver-reactive photoemissive layer (i.e., any layer whose composition includes a silver-reactive material). As used herein, “diffusion-resistant” means “having a diffusion coefficient less than 10⁻¹⁵ m²/sec at temperatures less than 300C for silver or a silver-reactive material.” Diffusion-resistant transparent conductors include, for example, zinc oxide (ZnO) and zinc-tin oxide (ZnSnO). The diffusion-resistant transparent conductor acts as a barrier layer to prevent reactions between the silver and the silver-reactive material. The barrier layer may be undoped, or it may be doped with 0.2-5 weight percent (wt %) Al, Ga, boron (B), or other dopants. The barrier layer has sufficient conductivity and transparency to ensure that it does not interfere with current or light entering or exiting the active stack.

The barrier layer may be formed by sputtering, a type of physical vapor deposition (PVD). The sputtering may be from a metal oxide target or from a metal target in an oxygen-containing atmosphere. If the barrier layer is to include two or more metals, the metals or their oxides may be co-sputtered from separate targets and their relative concentrations may be controlled via the plasma power density, substrate temperature, position, or orientation of the separate targets. An optional dopant for the barrier layer, if added, may be (1) incorporated in a sputtering target for another of the barrier materials, (2) co-sputtered from a separate target, (3) incorporated as one or more thin sub-layers, from which a subsequent thermal treatment may diffuse the dopant into other parts of the barrier layer, or (4) added after the barrier layer is formed, e.g., by ion implantation.

If the barrier layer is immediately adjacent to the silver layer, the silver layer may also be doped with up to 1 wt % palladium (Pd), nickel (Ni), tantalum (Ta), or titanium (Ti) for improved adhesion between the silver and the ZnO. The silver layer may be formed by PVD. The optional dopant, if added, may be incorporated in a sputtering target, may be co-sputtered, may be incorporated as one or more thin sub-layers that may be diffused by a subsequent thermal treatment, or may be added after the silver layer is formed, e.g., by ion implantation. In particular, a Ti dopant (0.2 wt %-5 wt %) in the silver also promotes growth at the optimal <111> crystal orientation and facilitates a smooth surface on the deposited film.

### BRIEF DESCRIPTION OF DRAWINGS

The accompanying drawings may illustrate examples of concepts, embodiments, or results. They do not define or limit the scope of invention. They are not drawn to any absolute or relative scale. In some cases, identical or similar reference numbers may be used for identical or similar features in multiple drawings.

FIGS. 1A and 1B conceptually illustrate examples of LEDs.

FIGS. 2A and 2B conceptually illustrate the effect of a barrier layer.

FIG. 3 is a conceptual diagram of a PVD chamber.

FIGS. 4A-4C are flowcharts of example processes related to forming a silver reflective contact with a diffusion-resistant transparent conductor as a barrier layer.

FIG. 5 is a flowchart of an example process for forming a silver reflective contact doped with titanium.

### DETAILED DESCRIPTION OF EXAMPLE EMBODIMENTS

Semiconductor manufacturing is generally a very complex process. Preceding and subsequent steps that do not necessarily affect the methods being described here, and techniques that are well known in the art, may be omitted to avoid excess length and confusion.

The arrangement of films and stacks within relevant devices may vary. While terms such as “above,” “below,” “over,” “under,” “top,” and “bottom” may be used herein for convenience in describing illustrated embodiments, inverted embodiments are also within the scope of invention. Similarly, some of the described processes, and subsets of steps within those processes, may be performed in reverse order to achieve the desired effect.

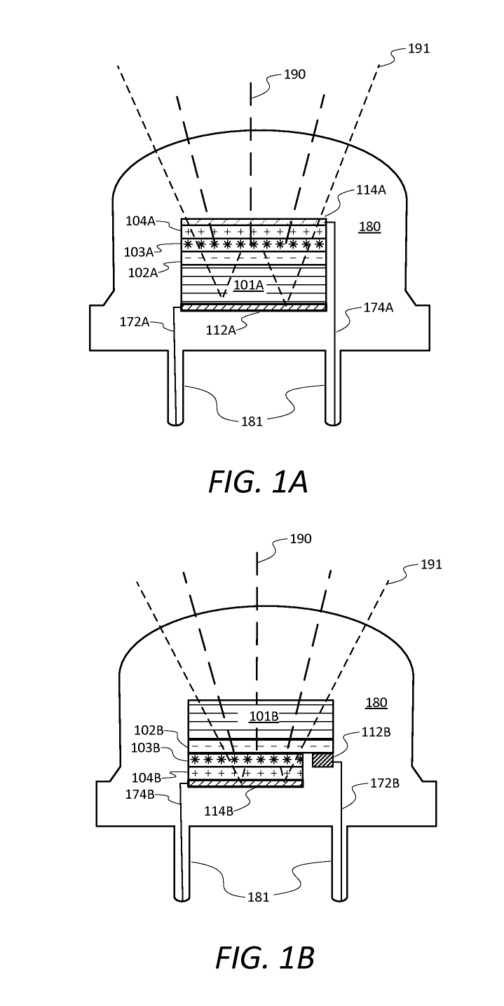

FIGS. 1A and 1B conceptually illustrate examples of LEDs. Many different LED designs exist, and new ones continue to be introduced. These examples are intended to provide basic context and do not limit the scope of application of the described reflective contacts.

FIG. 1A illustrates an example of a junction-up LED. Inside the transparent envelope of package 180, substrate 101A supports N-type semiconductor layer 102A, active photoemissive layer 103 A, and p-type semiconductor layer 104A (sometimes referred to as the “active stack.” Current delivered through terminal pins 181 is conducted through leads 172A and 174A to negative-polarity contact 112A and positive-polarity contact 114A. The current causes negative charge-carriers to migrate from N-type layer 102A into active photoemissive layer 103A, and positive charge-carriers to migrate from P-type layer 104A into active photoemissive layer 103A. When the negative charge-carriers and positive charge-carriers recombine in active photoemissive layer 103A, photons of light are emitted.

Upward-directed light 190 passes through positive-polarity contact 114A, illustrated here as a transparent electrode. In some LEDs, positive-polarity contact 114A is opaque or reflecting, but only covers part of the top surface so that light may emerge from the uncovered parts of the surface. Downward-directed light 191 passes through substrate 101 A and is reflected from reflective negative-polarity contact 112A to redirect it upward, where it exits from the top surface.

In some junction-up LEDs, reflective negative-polarity contact 112A is between substrate 101A and N-type layer 102A. These designs do not require substrate 101A to be transparent; it may be an opaque material such as silicon carbide. In some junction-up LEDs, the positive-polarity components are underneath the active photoemissive layer and the negative-polarity components are above it.

FIG. 1B illustrates an example of a flip-chip LED. When this LED chip was fabricated, the film stack was formed on substrate 101B. When the die was installed in package 180, it was flipped upside-down to position substrate 101B on top (the former “substrate” became a “superstrate”). Part of the surface of the N-type semiconductor layer 102B is exposed to allow the attachment of negative-polarity contact 112B. In some LEDs, this removes the requirement that negative-polarity contact 112B have any particular optical properties. When current passes through the device from pins 181 through leads 172B and 174B, light is emitted from active photoemissive layer 103B. Light emitted from active photoemissive layer 103B toward superstrate 101B is transmitted directly out of the device. Light emitted from active photoemissive layer 103B toward P-type layer 104B is reflected from reflective positive-polarity contact 114B, which redirects it upward through superstrate 101B.

Both of these designs, and others, make use of reflective contacts. A high-performance, reliable reflective contact that is cost-effective to manufacture would advance the technology and benefit the industry.

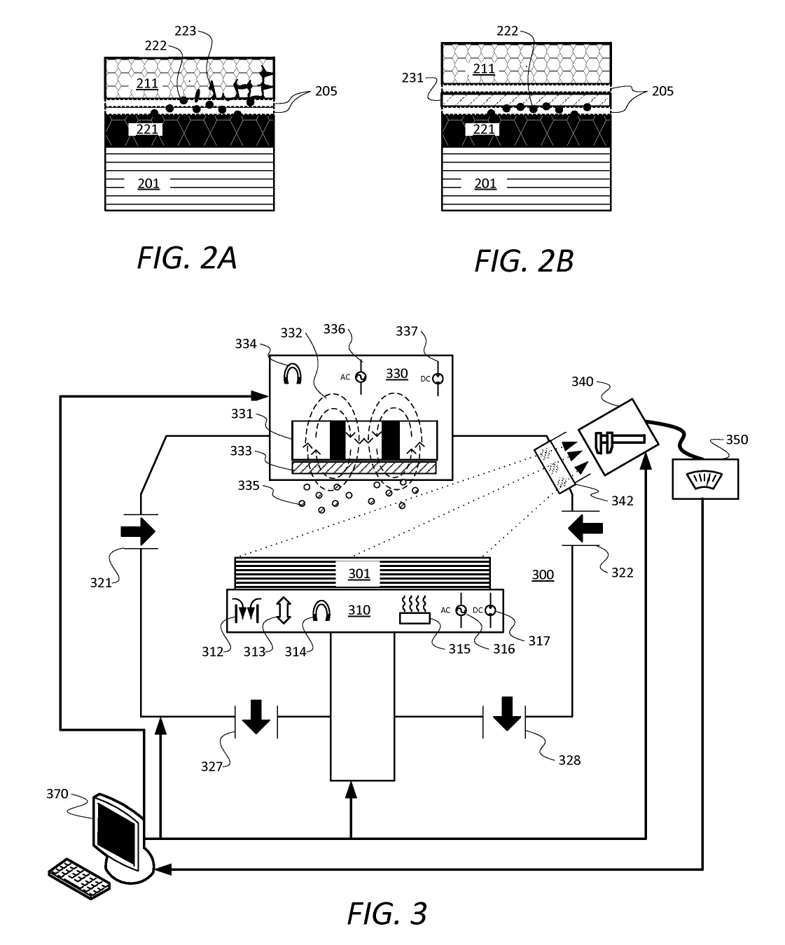

FIGS. 2A and 2B conceptually illustrate the effect of a barrier layer. In FIG. 2A, substrate 201 includes a silver layer 211 and a silver-reactive material layer 221 that include a silver-reactive material such as Ga, Al or another Group III metal. Substrate 201 may or may not have other structures underlying the illustrated layers. For example, substrate 201 may correspond to substrate 101A and silver layer 211 may correspond to reflective negative-polarity contact 112A. Alternatively, substrate 201 may correspond to substrate 101B and silver layer 211 may correspond to reflective positive-polarity contact 114B. Intervening silver-permeable layers 205 may separate silver layer 211 from silver-reactive material layer 221, or there may be no intervening layers and silver layer 211 and silver-reactive material layer 221 may be in direct contact.

During a high-temperature anneal, or gradually over the life of the device, silver-reactive material atoms 222 may diffuse out of silver-reactive material layer 221. Even if intervening layers 205 separate silver-reactive material layer 221 from silver layer 211, the silver reactive metal atoms 222 may eventually breach silver layer 211 if the intervening layers 205 are permeable. Upon reaching silver layer 211, silver-reactive material atoms 222 may wick or penetrate into grain boundaries 223 in the silver crystalline structure, corroding the silver and making it less reflective. Depending on the silver-reactive material, the extent of corrosion, and the corrosion mechanism, silver layer 211 may begin to lose its conductivity as well.

In FIG. 2B, a diffusion-resistant transparent conductive layer 231 is interposed as a barrier between silver-reactive material 221 and silver layer 211. Transparent conductive layer 231 does not interfere with the passage of either current or light through the stack. The material for diffusion-resistant transparent conductive layer 231 is selected to resist the diffusion of silver-reactive material atoms 222. If silver-reactive material atoms 222 diffuse, they are blocked by diffusion-resistant transparent conductive layer 231 before reaching silver layer 211. Meanwhile, diffusion-resistant transparent conductive layer 231 does not interfere with light or current passing through the stack. The stack may have intervening layers 205 between diffusion-resistant transparent conductive layer 231 and silver layer 211 or silver-reactive material layer 221. Alternatively, diffusion-resistant transparent conductive layer 231 may be in direct contact with silver layer 211, silver-reactive material layer 221, or both.

In some embodiments, a diffusion-resistant transparent conductive barrier layer includes a zinc-containing oxide, such as ZnO or ZnSnO, as a barrier to protect silver from corrosion or contamination by diffused gallium, aluminum, and similar silver-reactive materials. The zinc-containing oxide may be in an un-doped state or it may be doped with 0.2-5 wt % aluminum, gallium, or boron, because although metallic Al and Ga react with silver, their oxides do not. Both the zinc-containing oxide and the silver may be deposited by physical vapor deposition (PVD). In some embodiments, the diffusion-resistant transparent conductive layer may be between 5 and 30 nm. In some embodiments, the diffusion-resistant transparent conductive layer may be between 10 and 20 nm.

FIG. 3 is a conceptual diagram of a PVD chamber. Chamber 300 includes a substrate holder 310 for holding a substrate 301. Substrate holder 310 may include a vacuum chuck 312, translation or rotational motion actuators 313, a magnetic field generator 314, a temperature controller 315, and circuits for applying an AC voltage bias 316 or DC voltage bias 317 to substrate 301. Some chambers include masks (not shown) for exposing only part of substrate 301 to the PVD process. The masks may be movable independent of the substrate. Chamber 300 includes inlets 321, 322 and exhausts 327, 328 for process gases. Process gases for PVD may include inert gases such as nitrogen or argon, and may also include reactive gases such as hydrogen or oxygen.

Chamber 300 includes least one sputter gun 330 for sputtering elementary particles 335 (such as atoms or molecules) from a sputter target 333 by means of plasma excitation from the electromagnetic field generated by magnetron 331. Sputter gun 330 may include adjustments for magnetic field 334, AC electric field 336, or DC electric field 337. Some sputter guns 330 are equipped with mechanical shutters (not shown) to quickly start or stop the exposure of substrate 301 to elementary particles 335. Some PVD chambers have multiple sputter guns.

Some chambers 300 support measuring equipment 340 that can measure characteristics of the substrate 301 being processed through measurement ports 342. Results for measuring equipment 340 may be monitored by monitoring equipment 350 throughout the process, and the data sent to a controller 370, such as a computer. Controller 370 may also control functions of substrate holder 310, chamber 300 and its gas inlets and outlets 321, 322, 327, and 328, sputter gun 330, and measurement equipment 340.

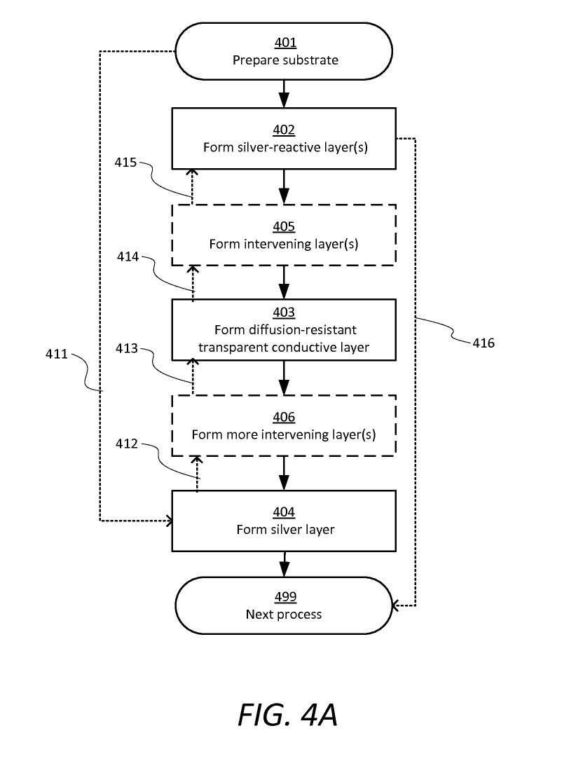

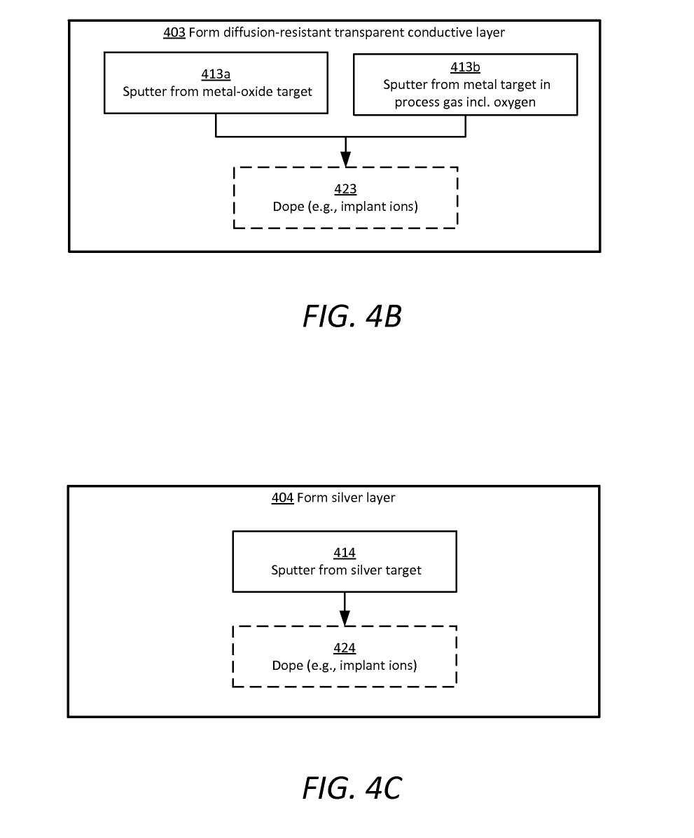

FIGS. 4A-4C are flowcharts of example processes related to forming a silver reflective contact with a diffusion-resistant transparent conductor as a barrier layer. Following the solid-line arrows on the chart, a substrate is initially prepared 401 and placed in a process chamber. The process may include a step 402 of forming one or more silver-reactive material layers, or the substrate itself may include a silver-reactive material. The process may also include an optional step 405 of forming one or more intervening layers above the silver-reactive material before step 403 of forming the diffusion-resistant transparent conductive layer. The process may also include an optional step 406 of forming one or more intervening layers above the diffusion-resistant transparent conductive layer before step 404 of forming the silver layer.

Note that if the silver-reactive material layers are farther from the substrate than the silver layer, the steps may be reordered according to the dashed-line arrows 411, 412, 413, 414, 415, and 416. The silver layer may be formed 404 on the substrate, then optional intervening layers may be formed 406, then the diffusion-resistant transparent conductive layer may be formed 403, then optional additional intervening layers may be formed 405, and finally the silver-reactive material layers may be formed 402. If there are silver-reactive material layers on both sides of the silver layer, a pair of diffusion-resistant transparent conductive layers may surround the silver layer. After the reflective contact including the silver layer and one or more diffusion-resistant transparent conductive layers are formed, the next process 499 may commence.

FIG. 4B describes alternative sub-operations that may be included in diffusion-resistant transparent conductive layer formation 403. The process may include step 413a of sputtering from a metal oxide target (e.g., ZnO or ZnSnO), or step 413b of sputtering a metal such as Zn or Sn from a purely metallic target in a process gas mixture that includes enough oxygen to form the metal oxide on the substrate. Either the metal-oxide target or the metal target may optionally incorporate dopants such as 0.2-5 wt % gallium, aluminum, boron, or an oxide of gallium, aluminum, or boron. For example, a target may be ZnO with 0.2-5 wt % Al₂O₃. Alternatively, a dopant may be co-sputtered from a separate target while sputtering the zinc-containing material. If the dopant in the target is a metal, it may be oxidized by exposure to oxygen on the substrate or in the chamber. Alternatively, the undoped zinc-containing oxide layer may be formed first by oxide-sputtering 413a or metal-sputtering 413b, followed by a step 423 of subsequent doping (for example, by ion implantation, or by thermal diffusion from an embedded or adjacent sub-layer).

FIG. 4C describes alternative steps that may be included in silver layer formation 404. In step 414, silver may be sputtered from a pure silver target or a doped silver target. Alternatively to incorporating the dopant in the silver sputtering target, the dopant may be co-sputtered with the silver, or a pure silver layer may be initially formed and followed by step 424 of subsequent doping, e.g. by ion implantation or thermal diffusion from an embedded or adjacent sub-layer.

In some embodiments, doping the silver with up to 1 wt % palladium, nickel, tantalum, or titanium improves adhesion and reduces agglomeration of silver deposited directly on a diffusion-resistant transparent conductive layer such as zinc-containing oxide. In some embodiments, titanium-doped silver crystallizes more predominantly into the optimally reflective <111> crystalline orientation than does undoped silver. For example, the crystalline orientation is predominantly <111> if more than 60% of the crystals are measured by X-ray diffraction (XRD) to be in the <111> orientation.

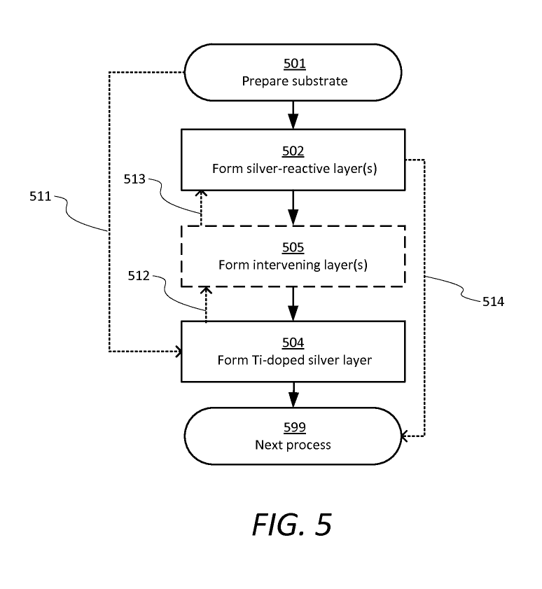

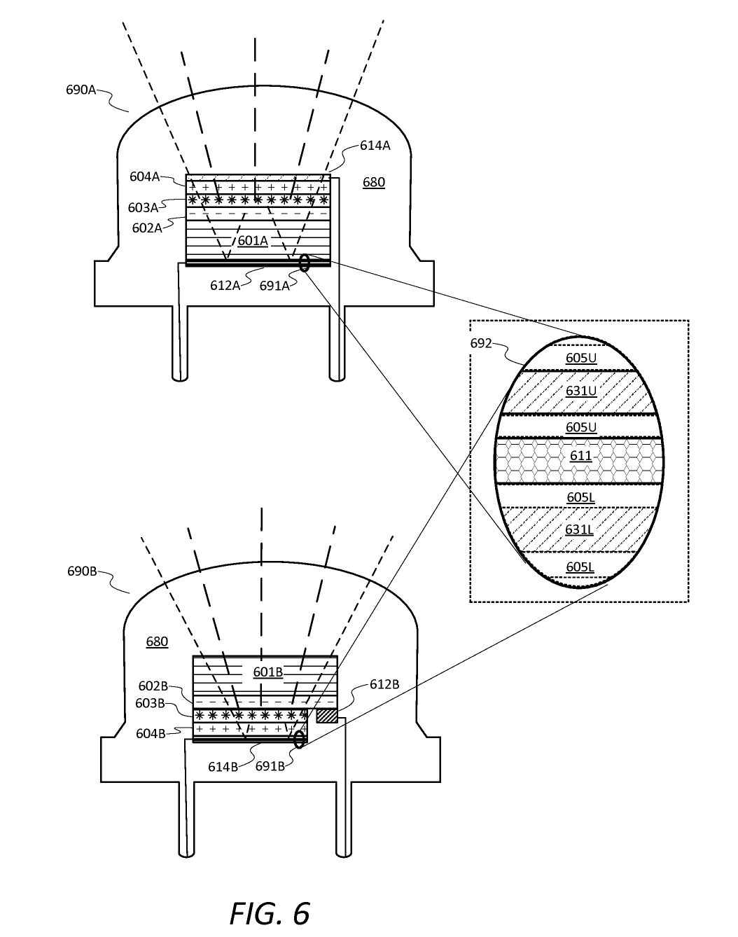

FIG. 5 is a flowchart of an example process for forming a silver reflective contact doped with titanium. After step 501 of substrate preparation, step 502 may include forming silver-reactive material layers. Alternatively, the substrate may already include a silver-reactive material (e.g., a GaN substrate). The process may also include an optional step 505 of forming one or more intervening layers above the silver-reactive material before step 504 of forming the titanium-doped silver layer. The Ti-doped silver layer may be formed 504 by any suitable method, including the sputtering approaches described with reference to FIG. 4C. Like the steps in FIG. 4A, the steps may be performed in the reverse order according to the dashed-line arrows 511, 512, 513, and 514 if the silver layer needs to be formed before the silver-reactive material layer. When the reflective contact including the titanium-doped silver is formed, the next process may commence 599.

FIG. 6 conceptually illustrates example LEDs with barrier-protected silver layers according to some embodiments. In junction-up LED 690A, the negative-polarity reflective contact 612A is barrier-protected silver. In flip-chip LED 690B, the positive-polarity reflective contact 612B is barrier-protected silver. Also shown are substrate 601A, n-type semiconductor layer 602A, active photoemissive layer 603A, p-type semiconductor layer 604A, and (transparent) positive-polarity contact 614A of junction-up LED 690A; and substrate 601B, n-type semiconductor layer 602B, active photoemissive layer 603B, p-type semiconductor layer 604B, and (partial-coverage) negative-polarity contact 612B of junction-up LED 690B.

To depict microscopic detail and macroscopic context in the same drawing, small areas (991A of reflective contact 612A and 691B of reflective contact 614B) are magnified in magnification view 692. At a minimum, each of the reflective contacts has a silver layer 611 and an upper diffusion-resistant transparent conductive barrier 631U. In some embodiments, silver layer 611 is undoped. In some embodiments, silver layer 611 is Ti-doped. To clarify, the upper “U” layers are between silver layer 611 and substrate 601A in LED 690A, and they are between silver layer 611 and p-type semiconductor layer 604B in LED 690A. Optionally, the reflective contacts may include intervening layers 605U above or below barrier 631U. Any barrier layer configuration described herein, or any combination or equivalent, may be used.

Optionally, one or more barrier layers 631L may be used below silver layer 611 to protect the silver layer from any unwanted interactions with materials in the LED packaging or leads, or with chemicals used in any other fabrication process. Optionally, the reflective contacts may include intervening layers 605L above or below barrier 631L. Any barrier layer configuration described herein, or any combination or equivalent, may be used. Where barriers are used both above and below the silver layer, the layers or stacks of the barriers or intervening layers may or may not be alike.

The reflective contacts described herein could potentially be used in many other configurations in any III-V device that uses a reflective contact with silver-like properties. This includes photosensors as well as other photoemitters such as diode lasers. Where a photoemitter emits light responsive to incoming current, a photosensor or photodetector emits current responsive to incoming light. If a silver film needs to have high reflectivity or be protected from corrosion by reaction with other metals in the stack, measures like those described herein, which do not interfere with the passage of current or light, are advantageous.

Although the foregoing examples have been described in some detail to aid understanding, the invention is not limited to the details in the description and drawings. The examples are illustrative, not restrictive. There are many alternative ways of implementing the invention. Various aspects or components of the described embodiments may be used singly or in any combination. The scope is limited only by the claims, which encompass numerous alternatives, modifications, and equivalents.

What is claimed is:

1. A method of fabricating a reflective contact on a substrate, the method comprising:
forming a transparent conductive layer above the substrate; and
forming a silver layer above the substrate;
wherein the transparent conductive layer is between the silver layer and a silver-reactive material; and
wherein the transparent conductive layer is resistant to diffusion of the silver-reactive material.

2. The method of claim 1, wherein the transparent conductive layer comprises a zinc-containing oxide.

3. The method of claim 1, wherein the transparent conductive layer comprises zinc oxide (ZnO) or zinc-tin oxide (ZnSnO).

4. The method of claim 1, wherein the transparent conductive layer comprises a first dopant.

5. The method of claim 4, wherein the first dopant comprises aluminum, gallium, or boron.

6. The method of claim 4, wherein a percentage of the first dopant in the transparent conductive layer is between about 0.2 wt % and 5 wt %.

7. The method of claim 4, wherein the first dopant is added after the transparent conductive layer is formed.

8. The method of claim 1, wherein the transparent conductive layer is formed by physical vapor deposition.

9. The method of claim 8, wherein a target used for the physical vapor deposition comprises zinc-containing oxide.

10. The method of claim 8, wherein a target used for the physical vapor deposition comprises metallic zinc; and wherein a process gas used for the physical vapor deposition comprises oxygen.

11. The method of claim 8, wherein a target used for the physical vapor deposition comprises tin oxide.

12. The method of claim 8, wherein a target used for the physical vapor deposition comprises metallic tin; and wherein a process gas used for the physical vapor deposition comprises oxygen.

13. The method of claim 8, wherein a target used for the physical vapor deposition comprises about 0.2-5 wt % aluminum, gallium, or boron.

14. The method of claim 1, wherein the silver layer comprises a second dopant.

15. The method of claim 14, wherein the second dopant comprises palladium, titanium, nickel, or tantalum.

16. The method of claim 14, wherein a percentage of the second dopant in the silver layer is between about 0.1 wt % and 1.1 wt %.

17. The method of claim 14, wherein at least 60% of the crystals in the silver layer are in the <111> orientation as measured by X-ray diffraction.

18. The method of claim 14, wherein the second dopant is added after the silver layer is formed.

19. The method of claim 1, wherein the silver layer is formed by physical vapor deposition.

20. The method of claim 19, wherein a target used during the physical vapor deposition comprises between about 0.01 wt % and about 1 wt % palladium, titanium, nickel, or tantalum.
